(19) United States
(12) Patent Application Publication
(10) Pub. No.: US 2019/0310370 A1
(43) Pub. Date: Oct. 10, 2019

(54) OPTOELECTRONIC SENSOR AND METHOD FOR DETECTION AND DISTANCE DETERMINATION OF OBJECTS

(71) Applicant: SICK AG, Waldkirch (DE)

(72) Inventor: Stephan SCHMITZ, Waldkirch (DE)

(21) Appl. No.: 16/377,896

(22) Filed: Apr. 8, 2019

(30) Foreign Application Priority Data
Apr. 9, 2018 (DE) 102018108340.8

(51) Int. Cl. G01S 17/10; G01S 17/02; G01S 7/484

(52) U.S. Cl. CPC G01S 17/10; G01S 7/484; G01S 17/026

(57) ABSTRACT

An optoelectronic sensor (10) for detecting and determining the distance of objects in a monitoring region (16), the sensor (10) having a light transmitter (12) for transmitting a transmission light beam (18) with a modulated pulse sequence coding, a light receiver (24) for generating a reception signal from the remitted light beam (20) remitted by objects in the monitoring region (16), and a control and evaluation unit (26) which is configured to determine a light time of flight based on the reception signal and the associated pulse sequence coding and, therefrom, a distance value, wherein the light transmitter (12) is configured to simultaneously transmit a plurality of transmission light beams (18) with a modulated pulse sequence coding for scanning a plurality of measuring points (28), and wherein the light receiver (24) comprises a plurality of light receiving elements for generating a plurality of reception signals from a plurality of remitted light beams (20).

The invention relates to an optoelectronic sensor and a method for the detection and distance determination of objects in a monitoring region.

Some optoelectronic sensors, including a laser scanner and a 3D camera, also capture depth information. The result is three-dimensional image data, also known as a distance image or depth map. The additional distance dimension can be used in a variety of applications to gain more information about objects in the captured scenery and thus solve different tasks.

Various methods are known for determining the depth information. In a time-of-flight measurement (TOF) considered here, a scene is illuminated with pulsed or amplitude-modulated light. The sensor measures the time of flight of the reflected light. In a pulse method, light pulses are transmitted and the duration between transmission and reception time is measured. A phase method uses periodic amplitude modulation and measurement of the phase shift between transmitted and received light.

In a 3D camera, the time of flight of flight is measured for respective pixels or pixel groups. For example, in a pulse method, TDCs (time-to-digital converter) are connected to the pixels for time of flight measurements, or are integrated on a wafer together with the pixels. One technology for obtaining three-dimensional image data using a phase method is a photonic mixing device (PMD).

In a laser scanner, a light beam generated by a laser periodically scans the monitored area with the aid of a deflection unit. In addition to the measured distance information, the angular position of the object is inferred from the angular position of the deflection unit, and thus image data with distance values in polar coordinates are generated after a scanning period. By additional variation or multi-beam scanning in the elevation angle, three-dimensional image data are generated from a spatial area. In most laser scanners, the scanning movement is achieved by a rotating mirror. However, it is also known that the entire measuring head with one or more light transmitters and light receivers can be rotated instead, as described for example in DE 197 57 849 B4.

3D cameras and laser scanners each have advantages and disadvantages that need to be balanced when selecting the appropriate sensor for a particular application. With a 3D camera, it is possible to capture a large area at once without moving mechanical parts. Although the laser scanner requires a rotation and a certain measuring time, in particular when scanning a 3D area, it focuses the transmission energy on one point and thus gains range and more reliable measured values.

There are approaches in the prior art to build an area scanning system without a rotating deflection unit. For example, in EP 2 708 914 A1 the pulsed transmission light beam of a light source is guided over the area to be scanned in the X-direction and Y-direction by means of a MEMS mirror. The reflected light pulses are received by a SPAD matrix (Single-Photon Avalanche Diode), where only those respective SPADs are activated that observe the area currently illuminated by the transmission light beam. Thus, it is achieved to get rid of a rotating system, but the scanning process takes too long for a fast image acquisition at least at a high resolution.

It is known for light grids, for example from EP 2 012 144 B1 and EP 2 103 962 B1, to modulate the respective light beams with pulse sequences orthogonal to each other. This makes it possible to break up the cyclic activation sequence of the light beams, which is usual for common light grids, and to operate light transmitters simultaneously. The useful signal of the respective opposite light transmitter is distinguished from other light transmitters, and also from ambient light, by means of the expected pulse sequence expected. However, a light grid is not a suitable sensor for acquiring a depth map.

EP 2 626 722 B1 discloses a laser scanner that modulates its scanning beam with a pseudorandom code sequence and measures light times of flight by correlation with the pseudorandom code sequence. This makes the laser scanner more robust against ambient light and multiple reflections, but the system continues to be based on a rotating deflection unit, with the aforementioned disadvantages of risk of failure and costs. In addition, area scanning is only possible if there is an additional deflection in elevation, and in that case the measuring periods will be very long. EP 2 626 722 B1 also introduces a specific pseudo-random code sequence consisting of a first compressed and a second stretched part. This improves the measuring behavior, but does not solve the fundamental problems mentioned above.

EP 2 730 942 B1 also is concerned with a laser scanner that improves its signal-to-noise behavior by pseudo-random sequences. In that case the core feature is that the binary pseudo-random sequence has many zeros and only a few ones. The signal thus has more high-frequency components that can be separated from low-frequency noise of ambient light. Once again, however, the basic disadvantages of a laser scanner are not resolved.

It is therefore an object the invention to provide an improved distance-measuring sensor.

This object is satisfied by an optoelectronic sensor for detecting and determining the distance of objects in a monitoring region, the sensor having a light transmitter for transmitting a transmission light beam with a modulated pulse sequence coding, a light receiver for generating a reception signal from the remitted light beam remitted by objects in the monitoring region, and a control and evaluation unit which is configured to determine a light time of flight based on the reception signal and the associated pulse sequence coding and, therefrom, a distance value, wherein the light transmitter is configured to simultaneously transmit a plurality of transmission light beams with a modulated pulse sequence coding for scanning a plurality of measuring points, and wherein the light receiver comprises a plurality of light receiving elements for generating a plurality of reception signals from a plurality of remitted light beams.

The object is also satisfied by a method for detecting and determining the distance of objects in a monitoring region, wherein a transmission light beam with a modulated pulse sequence coding is transmitted, a reception signal is generated in a light receiver from a remitted light beam remitted by objects in the monitoring region and is evaluated taking into account the associated pulse sequence coding in order to determine a light time of flight and, therefrom, a distance value, wherein a plurality of transmission light beams with a modulated pulse sequence coding are transmitted simultaneously for scanning a plurality of measuring points, a plurality of reception signals are generated from the remitted light beams in different light receiving elements of the same light receiver and these are correlated with the associated pulse sequence coding in order to determine respective distance values to the plurality of measuring points.

The sensor acquires three-dimensional image data by its distance measurement, which can be detected over a large area, but the lateral distribution of the measuring points can also be limited to one or more partial areas (ROI, Region of Interest). The sensor comprises a light transmitter for generating a transmission light beam with pulse sequence coding and a light receiver for receiving the remitted light beam which has been remitted in the monitored area. A control and evaluation unit measures the light time of flight using the reception signal of the light receiver and the known modulated pulse sequence, in particular by correlating the reception signal with the pulse sequence, and on that basis determines a distance value to the scanned object which has reflected the transmission light beam.

The invention starts from the basic idea of simultaneously measuring with several transmission light beams. The transmission light beams each are modulated with a pulse sequence coding, and they are detected by different light receiving elements of the light receiver to generate multiple reception signals. The control and evaluation unit can thus determine several distances to several measuring points from the reception signals at the same time. The light receiving elements of the light receiver are adjacent, in particular because the light receiver is designed as a pixel matrix, and not spatially separated with mutual distance as with a light grid. A light grid would also not receive remitted light beams, but would directly receive the transmission light beam itself with an opposing light receiver. Simultaneous transmission does not necessarily mean that the pulse sequences begin and/or end at the same time, but in any case the time interval overlaps in which pulse sequences of several transmission light beams are transmitted.

The invention has the advantage that by parallel acquisition of several measuring points a fast scanning of a large range and thus a fast response time of the sensor is achieved. It is also conceivable to capture certain ROIs with particularly large lateral spatial resolution and/or accuracy of distance measurement. The pulse sequences make it possible to separate ambiemt light and to therefore achieve a high signal-to-noise behavior with corresponding robustness and accuracy of measurement as well as a long range. Compared to the area illumination of a 3D camera, the light output is concentrated on the measuring points, which further improves the signal-to-noise ratio.

The pulse sequences modulated on the plurality of transmission light beams preferably are different from one another, in particular orthogonal to one another. Throughout this specification, the terms preferred or preferably refer to an advantageous, but completely optional feature. The control and evaluation unit can thus identify and distinguish the transmission light beams by correlation with the different pulse sequences. Thus, if light components of an unrelated transmission light beam are scattered or remitted onto a light receiving element, this has only minor effects similar to ambient light due to the inappropriate pulse sequence. Orthogonal pulse sequences have the characteristic of practically not correlating with each other at all, and thus the assignment of the transmission light beam to the light receiving element that observes the measuring point illuminated by that transmission light beam is particularly accurate.

Pseudo-random code sequences are preferably used as pulse sequences, in particular binary codes whose ones are each coded by a pulse. An example of suitable pseudorandom code sequences are m-sequences (maximum length sequence). In principle, other pseudorandom code sequences can also be used, an exemplary selection including Barker codes, Gold codes, Kasami sequences or Hadamar Walsh sequences.

The pulse sequences preferably have a first part with a narrower time grid and a second part with a larger time grid, as described in EP 2 626 722 B1 mentioned in the introduction. In addition, the proportion of zeros in the pulse sequence preferably pre-dominates, in particular predominates very clearly, in correspondence with EP 2 730 942 B1 also mentioned in the introduction. It is referred to these documents for more detailed explanations and the benefits that can be achieved. A high proportion of zeros has the particular advantage in the context of the invention that, despite the simultaneous transmission of transmission light beams, only a single or at most a few bits of state one, i.e. pulses, usually need to be generated at any moment. This enables a high laser power without the transmitted light power strongly increasing due to the several transmission light beams.

The light transmitter preferably is configured to transmit at least one transmission light beam in varying directions, so that the measuring point illuminated by the transmission light beam in the monitoring region is observed by another light receiving element. For this purpose, an individual or coupled deflection can be provided for several or all transmission light beams in order to deflect transmission light beams individually, in groups or all of them in one or two lateral directions. Thus the measuring points of the transmission light beams are freely selectable, at least within the limits of the possible deflection. It is also possible to fix certain measuring points such as ROIs or to scan the entire monitoring area. Due to the multiple transmission light beams, such scanning is significantly accelerated.

The light transmitter preferably comprises a line array of light sources. This means that an entire line, preferably the entire horizontal or vertical field of view, can be captured simultaneously.

The light transmitter preferably is configured to transmit the transmission light beams in varying directions transversely to the line array. If the directions are varied together, the line arrangement scans the entire monitoring area. In contrast to a punctiform scanning as for example in EP 2 708 914 A1 mentioned in the introduction, this is faster by a factor which corresponds to the number of measuring points in line direction. It is also conceivable to change the directions across the line arrangement not for all transmission light beams, but individually or in groups. The line thus adapts to a contour that corresponds, for example, to an edge or generally to an ROI.

Preferably, a change of direction is also possible in the other direction along the line arrangement. This allows a shorter line arrangement, which does not cover the full field of view in line direction, to effectively be extended by scanning. Furthermore, it is possible to increase the resolution in line direction according to the principle of super resolution by moving to intermediate positions.

A pattern generating element, in particular a DOE (diffractive optical element), preferably is associated with the light transmitter in order to generate a plurality of transmission light beams from a light beam impinging on the pattern generating element. This splits or multiplies a transmission light beam. The resulting partial transmission light beams are then inevitably coded with the same pulse sequence. However, they can be spaced relatively far apart by the pattern generation element so as not to interfere or to interfere only slightly with each other. If a light transmitter with several light sources is used, nested patterns can be created, which also become denser, but in which measuring points with the same pulse codes keep quite a large distance from each other.

The control and evaluation unit preferably is configured to activate or read only those respective light receiving elements which observe the measuring points illuminated by the transmission light beams. Thus no reception signals are generated or evaluated by light receiving elements that cannot contribute to the useful signal. With a SPAD matrix being the light receiver, SPADs can be switched inactive by lowering the bias voltage below the breakdown voltage. They then lose several orders of magnitude in sensitivity and can therefore be regarded as switched off. Switching inactive also has the advantage that no unnecessary avalanches are triggered, which only contribute to power consumption and heat generation. However, it is also possible, independently of the technology, to let the unneeded light receiving elements remain active and only not to read out their reception signal or not to take it into account in the evaluation. Instead of at the level of the light receiver, it is also possible to already optically ensure that the unneeded light receiving elements do not receive any light, for example with an electro-optical shutter. Dark noise is not eliminated in this way, and this can have a considerable contribution for SPADs in particular.

The sensor preferably is configured as a laser scanner and has a rotatable deflection unit for periodically scanning the monitoring region. The rotating deflection unit is a rotating mirror, in particular a polygon mirror wheel, for periodic beam deflection with stationary light transmitter and light receiver, or alternatively a rotating deflection unit with light transmitter and light receiver moving along. In contrast to the known laser scanners mentioned in the introduction, a laser scanner according to the invention is a multi-beam scanner whose several transmission light beams are coded with pulse sequences.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

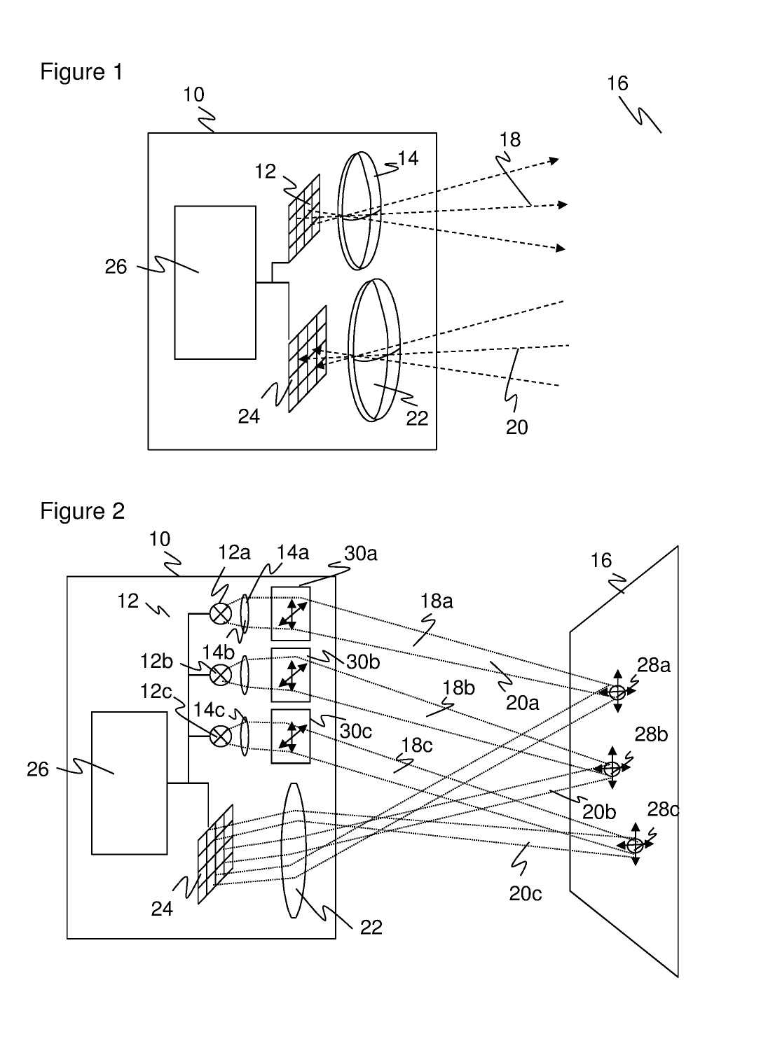

FIG. 1 a schematic representation of a distance-measuring optoelectronic sensor with matrix arrangements of light sources and light receiving elements;

FIG. 2 a schematic representation of a further embodiment of the sensor with variably adjustable light transmitters;

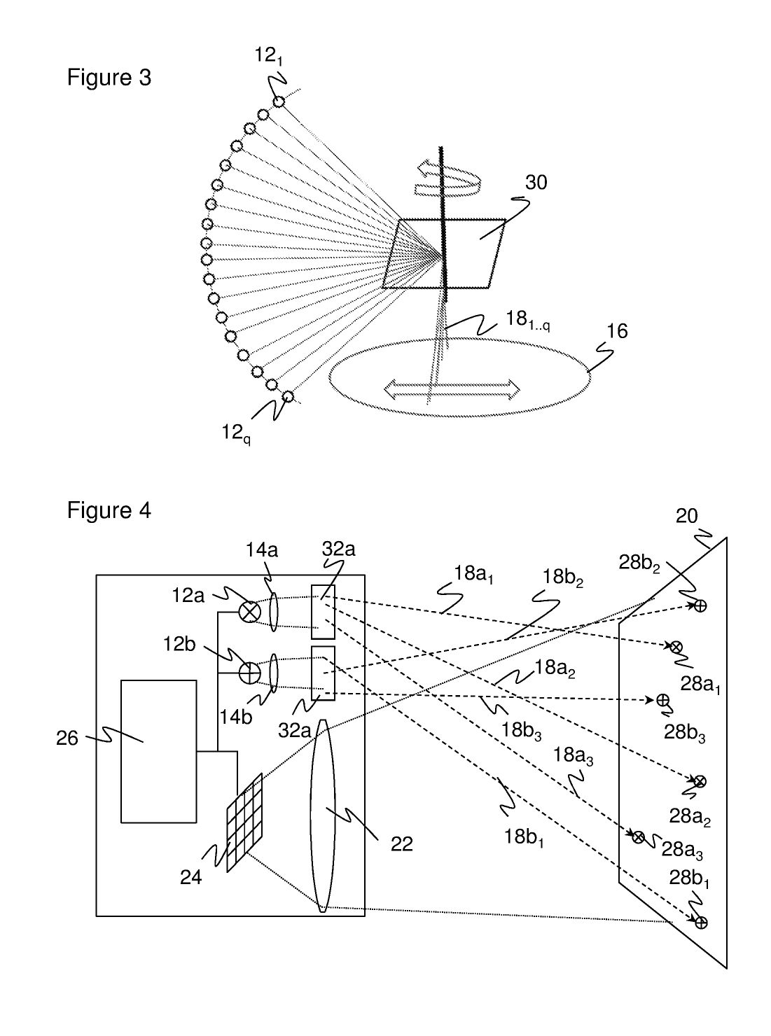

FIG. 3 a schematic representation of a further embodiment of the sensor with a linear arrangement of light transmitters and deflection perpendicular to the linear arrangement;

FIG. 4 a schematic representation of a further embodiment of the sensor with multiplication of the illuminated measuring points by means of a DOE; and

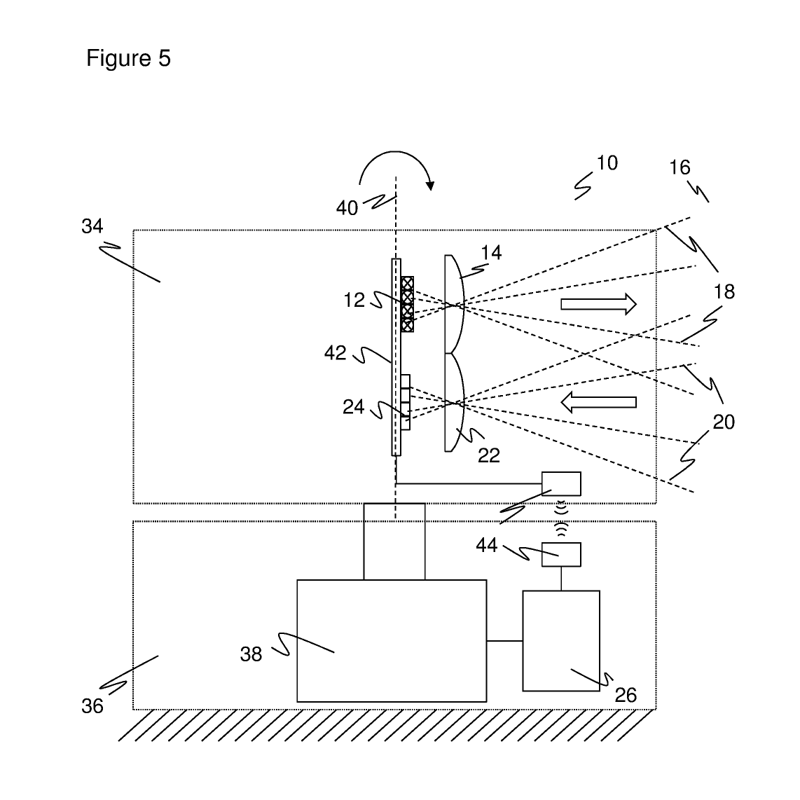

FIG. 5 a schematic representation of a further embodiment of the sensor as a laser scanner.

FIG. 1 shows a schematic representation of a distance-measuring optoelectronic sensor 10. By means of a light transmitter 12, modulated transmitted light is transmitted through a transmission optics 14 into a monitoring area 16. The light transmitter 12 is able to generate transmitted light in several transmission light beams 18. This allows the available light output to be concentrated on the actual measuring points, which significantly improves the signal-to-noise ratio in contrast to simple area illumination. As light transmitter 12, an array with a large number of individually or group controllable individual light transmitters is used, for example a VCSEL array. Other suitable light transmitters 12 are a multiple arrangement of other light sources, such as LEDs or edge emitting laser diodes, or an optical phased array, and further embodiments will be explained later with reference to FIGS. 2 to 4.

The light transmitter 12 modulates each of the transmission light beams 18 with a pulse sequence. Unless the same pulse sequence is used in all transmission light beams 18, it is necessary not only to be able to switch the individual light transmitters on and off individually or in groups, but also to be able to control them with different modulations. The transmission light beams 18 can then be distinguished by their pulse sequences, and measurements can thus be taken simultaneously at several measuring points. Simultaneously does not necessarily mean that the measurements must be completely synchronous, but that they may overlap in time.

The preferred pulse sequences are binary codes whose ones correspond to the pulses. The pulse sequences of the various transmission light beams 18 can be pseudo-random codes. They are as uncorrelated as possible or even quasi-orthogonal to one another, such as m-sequences, Barker codes, Gold codes, Kasami sequences or Hadamar-Walsh sequences. It is also possible to first compress the pulse sequences over time and then stretch them and/or to use pulse sequences mainly with zeros, as described in EP 2 626 722 B1 and EP 2 730 942 B1 mentioned in the introduction. Assuming typical pulse widths of 250 ps or less as a numerical example, a total of 80,000 time slots can be used over a period of 20 μs.

Now, if the transmission light beams 18 impinge on objects in the monitoring area 16, they are reflected back to the sensor 10 as remitted light beams 20. The remitted light beams 20 reach a light receiver 24 through a receiving optics 22. As with the transmission optics 14, the receiving optics 22 is only shown as a simple lens, which represents any optics with multi-lens objectives, apertures and other optical elements. Reflective or diffractive optics are also conceivable. The basic biaxial optical design with adjacent light transmitter 12 and light receiver 24 is also not required and can be replaced by any design known from single-beam optoelectronic sensors. An example of this is a coaxial arrangement with or without beam splitter.

The light receiver 24 comprises a large number of light receiving elements and in this example is configured as a SPAD array. SPADs are highly sensitive and highly integrable, and they offer the possibility of becoming virtually inactive by lowering the bias voltage below the breakdown voltage. Therefore, only those SPADs can be activated which correspond to the desired measuring points and thus to the expected locations where the remitted light beams 20 impinge. As an alternative to a SPAD array, a multiple arrangement of photodiodes or APDs or another matrix receiver, e.g. in CCD or CMOS technology, is conceivable, in which only certain pixels or pixel groups are read out according to the desired measuring points. This advantageous limiting of the field of view to the currently illuminated measuring points reduces the power dissipation and increases the robustness against ambient light. Alternatively, the field of view can also be optically limited to darken non-illuminated areas, for example with an electro-optical shutter.

A control and evaluation unit 26 is connected to the light transmitter 12 and the light receiver 24. It activates and modulates the desired individual light transmitters or VCSELs in order to generate the transmission light beams 18 modulated with pulse sequences. The reception signals, preferably only of the light receiving elements or SPADs actually illuminated by remitted light beams, are evaluated in order to determine a light time of flight to the measuring points of the scanned objects in the monitoring area, and their distance from that. For example, for light time of flight measurement, each of the reception signals is correlated with the pulse sequence used to modulate the associated transmission light beam 18. In the correlation signal obtained in this way, the evaluation unit 26 then determines the position of the correlation maximum and from this a reception time. At least parts of the control and evaluation unit 26 can be integrated with the light transmitter 12 or the light receiver 24 on a common module, for example a signal generation for the modulation of the transmission light beams 18 or pixel-related evaluations and correlations of the reception signal.

Due to the pulse coding, a simultaneous measurement with several transmission light beams 18 is possible, which is particularly robust with regard to mutual light interference as well as ambient light. This combines the advantages of a laser scanner and a 3D camera: The distance values are acquired at several measuring points, significantly faster than with sequential detection with only one transmission light beam, and still with concentration of the measuring light at one measuring point, unlike with area illumination and acquisition.

FIG. 2 shows a schematic representation of a further embodiment of the sensor 10. In the embodiment shown in FIG. 1, a matrix arrangement of individual light transmitters is provided as light transmitter 12, and the orientation or alignment of the transmission light beams 18 is effected by selecting certain activated individual light transmitters. In contrast to this, the light transmitter 12 according to FIG. 2 has several, in this example three light transmitters 12a-c which can be variably aligned. This allows the transmission light beams 18a-c to be aligned to certain variable measuring points 28a-c. Again, light receiving elements of the light receiver 24 are preferably only activated or read out where the remitted light beams 20a-c are expected in the current alignment of the transmission light beams 18a-c.

In FIG. 2, the deflection of the transmission light beams 18a-c is only schematically shown by adjustment units 30a-c. There are various implementations, such as piezo actuators which change the lateral position of the transmission optics 14a-c or, since it is the relative position between them which is important, the individual light transmitters 12a-c. Further examples are additional optical elements such as MEMS mirrors, rotating mirrors, rotating prisms or an acousto-optical modulator. Another preferred embodiment uses a liquid lens as the transmission optics 14a-c, wherein the boundary layer between two immiscible media can be tilted by controlling an electrode arrangement.

In any case, by means of the adjustment units 30a-c, the associated measuring point 28a-c can be shifted laterally or in XY direction perpendicular to the Z direction in which the sensor measures 10 distances. This opens up a multitude of application possibilities. An area scan in which the measuring points 28a-c together systematically scan the entire monitoring area 16 is faster than a conventional system, for example according to the EP 2 708 914 A1 mentioned in the introduction, by a factor corresponding to the number of individual light transmitters 12a-c. However, it is also conceivable to scan one or more ROIs in a targeted manner. In particular, the measurement time can be extended to improve the distance measurement by averaging or other statistical methods, or the now smaller area can be scanned with a finer grid to increase the lateral spatial resolution.

FIG. 3 shows a schematic representation of a further embodiment of the sensor 10, wherein the light transmitter 12 has a linear arrangement of q individual light transmitters 12₁-12_{q} which preferably emit q pulse sequences orthogonal to one another. A respective collimating transmission optics is not shown for the sake of simplicity. Only the transmission path is shown, and for example a SPAD matrix can be used as light receiver 24.

Thus, the entire vertical field of view can already be covered. In a possible embodiment only such an elongated area is to be observed. Preferably, however, an adjustment unit 30 is provided as shown in order to deflect the represented vertical line over a horizontal angle and thus enable an area scan. The terms vertical and horizontal are of course interchangeable in this context. A MEMS mirror is provided as the adjustment unit 30, but the alternatives presented with reference to FIG. 2, such as piezo actuators for individual light transmitters 12₁-12_{q} or transmission optics, liquid lenses and the like are also conceivable. In particular, the individual light transmitters 12₁-12_{q} can be VCSEL lines or a common VCSEL matrix with separate modulation of the VCSEL columns.

Then, the source point of the transmission light beams 18_{1 . . . q} travels horizontally, which may concern all transmission light beams 18_{1 . . . q} for an area scan and/or individual transmission light beams 18_{1 . . . q} in order to provide curvature to the simultaneously measuring line.

It is also possible to generate a vertical movement with the adjustment unit 30 in order to enlarge the vertical field of view by scanning and/or to refine the vertical spatial resolution. For improved spatial resolution, the vertical intervals in between the individual light transmitters 12₁-12_{q} are targeted and thus reduced in size once or several times.

If in a preferred embodiment the pulse sequences predominantly show zeros as explained in EP 2 730 942 B1, two individual light transmitters 12₁-12_{q} are rarely or never active at the same time. They still transmit pulse sequences simultaneously, but it virtually does not happen that they also simultaneously transmit a one, i.e. a pulse, at a given point in time. This means that the power supply can be very simple, no simultaneous power needs to be available for many or even all individual light transmitters 12₁-12_{q}.

Crosstalk is no longer to be expected for transmission light beams 18 and thus measuring points 28 which are far enough apart. If it can therefore be guaranteed that the spatial separation is maintained on the light receiver 24, pulse sequences may also be repeated, i.e. several individual light transmitters 12₁-12_{q} may use the same pulse sequence under the specified condition. This allows the number of simultaneously operated individual light transmitters 12₁-12_{q} to be further increased for a given code length.

In the embodiment according to FIG. 3, it is advantageous to limit the active detection region on the light receiver 24 to the currently illuminated measuring points 28 by selective active switching or reading out of only certain light receiving elements, or alternatively by optical limitation such as with an electronic shutter. In this case, the active detection region would preferably be the respective line-shaped section corresponding to the current position of the linear arrangement of individual light transmitters 12₁-12_{q}.

FIG. 4 shows a schematic representation of a further embodiment of the sensor 10. Instead of an adjustment unit 30, a pattern generating element 32a-b, in particular a DOE, is assigned to each of the two individual light transmitters 12a-b of this example.

The pattern generation elements 32a-b could also be combined in a common pattern generation element.

The pattern generating element 32a-b multiplies the respective incident light beam of the individual light transmitter 12a-b and thus generates several transmission light beams 18a_{1 . . . 3}, 18b_{1 . . . 3}. The associated remitted light beams 20 are not shown for the sake of clarity.

The corresponding measuring points 28a_{1 . . . 3}, 28b_{1 . . . 3} of a same individual light transmitter 12a-b are far enough apart to satisfy the condition of sufficient spatial separation described above. Thus in spite of the transmission light beams 18a_{1 . . . 3}, 18b . . . 3 of a same individual light transmitter 12a-b being coded with the same pulse sequence, mutual interference is prevented by the arrangement or design of the pattern generating elements 32a-b. For measuring points 28a_{1 . . . 3}, 28b_{1 . . . 3} of different individual light transmitters 12a-b a close neighborhood is allowed, since the pulse sequences differ. Thus, the neighborhood condition is not a serious practical constraint as it can be almost eliminated by interlocking lighting patterns.

It is conceivable to additionally provide an adjustment unit 30 as in the embodiment according to FIG. 2 in order to perform a scanning movement with the pattern of measuring points 28a_{1 . . . 3}, 28b_{1 . . . 3}, in particular in an embodiment with only one individual light transmitter 12a and one pattern generating element 32a.

FIG. 5 shows a schematic sectional view of an optoelectronic sensor 10 in a further version as a multi-beam laser scanner. The sensor 10 comprises a movable deflection unit 34 and a base unit 36. The deflection unit 34 is the optical measuring head, while the base unit 36 contains further elements such as a supply, evaluation electronics, connections and the like. During operation, a drive 38 of the base unit 36 is used to rotate the deflection unit 34 about a rotary axis 40 in order to periodically scan a monitoring area 16.

The deflection unit 34 has at least one scanning module which is configured as a four beam system with four individual light transmitters and four light receiving elements. Accordingly, four pulse-coded transmission light beams 18 are generated in this case. This structure of the scanning module is purely exemplary; in principle, all sensors 10 presented in FIGS. 1 to 4 can form a scanning module in a rotating system or be provided several times as multiple scanning modules. This enables a wide variety of beam arrangements and, in some cases, superimpositions of scanning movements, for detecting or scanning measuring points 28 or the monitoring area 16.

Light transmitter 12 and light receiver 24 in this embodiment are arranged together on a printed circuit board 42, which is arranged on the axis of rotation 40 and is connected to the shaft of the drive 38. This it to be understood as an example, practically any number and arrangement of printed circuit boards is conceivable.

A contactless supply and data interface 44 connects the movable deflection unit 34 and the stationary base unit 36, where the control and evaluation unit 26 is located, which can at least partly also be accommodated on the circuit board 42 or elsewhere in the deflection unit 34. In addition to the functions already described, the control and evaluation unit 40 also controls the drive 38 and receives the signal from an angle measuring unit which is not shown and is generally known from laser scanners and which determines the respective angle position of the deflection unit 34.

During a revolution, one plane is scanned with each transmission light beam 18, whereby measuring points 28 are generated in polar coordinates from the angular position of the scanning unit 34 and the distance measured by means of light time of flight. Strictly speaking, only at an elevation angle of 0°, i.e. a horizontal transmission light beam 18 not present in FIG. 5, a real plane is scanned. Other transmission light beams 18 having some elevation scan the outer surface of a cone having different inclination depending on the elevation angle. With several transmission light beams 18, which are deflected upwards and downwards at different angles, a kind of nesting of several hourglasses is created as a scanning structure. By further movement of the transmission light beams 18 as in one of the embodiments discussed with reference to FIGS. 1 to 4, or an elevation movement of the deflection unit 34, the scanning structure becomes even more complex and can thus be adapted for a desired detection in extension and local scanning density of the spatial monitoring area 16. In any case, the simultaneous scanning with several transmission light beams 18 made possible by pulse coding significantly speeds up the acquisition compared to conventional laser scanners.

The sensor 10 shown is a laser scanner with a rotating measuring head, namely the deflection unit 34. Alternatively, periodic deflection by means of a rotating mirror or a facetted mirror wheel is also conceivable. A further alternative embodiment swivels the deflection unit 34 back and forth, either instead of the rotary movement or additionally around a second axis perpendicular to the rotary movement, in order to generate a scanning movement also in elevation. However, such movements are preferably achieved with one of the principles presented in FIGS. 1 to 4 instead.

1. An optoelectronic sensor (10) for detecting and determining the distance of objects in a monitoring region (16), the sensor (10) having a light transmitter (12) for transmitting a transmission light beam (18) with a modulated pulse sequence coding, a light receiver (24) for generating a reception signal from the remitted light beam (20) remitted by objects in the monitoring region (16), and a control and evaluation unit (26) which is configured to determine a light time of flight based on the reception signal and the associated pulse sequence coding and, therefrom, a distance value,
wherein the light transmitter (12) is configured to simultaneously transmit a plurality of transmission light beams (18) with a modulated pulse sequence coding for scanning a plurality of measuring points (28),
and wherein the light receiver (24) comprises a plurality of light receiving elements for generating a plurality of reception signals from a plurality of remitted light beams (20).

2. The sensor (10) according to claim 1,
wherein the pulse sequences modulated on the plurality of transmission light beams (18) are different from one another.

3. The sensor(10) according to claim 2,
wherein the pulse sequences modulated on the plurality of transmission light beams (18) are orthogonal to one another.

4. The sensor (10) according to claim 1,
wherein the light transmitter (12) is configured to transmit at least one transmission light beam (18) in varying directions, so that the measuring point (28) illuminated by the transmission light beam (18) in the monitoring region (16) is observed by another light receiving element.

5. The sensor (10) according to claim 1,
wherein the light transmitter (12) comprises a line array of light sources (12_{1 . . . q}).

6. The sensor (10) according to claim 4,
wherein the light transmitter (12) is configured to transmit the transmission light beams (18) in varying directions transversely to the line array.

7. The sensor (10) according to claim 1,
wherein a pattern generating element (32) is associated with the light transmitter (12) in order to generate a plurality of transmission light beams (18a_{1 . . . 3}, 18b_{1 . . . 3}) from a light beam impinging on the pattern generating element (32).

8. The sensor (10) according to claim 1,
wherein the control and evaluation unit (26) is configured to activate or read only those respective light receiving elements which observe the measuring points (28) illuminated by the transmission light beams (18).

9. The sensor (10) according to claim 1,
which is configured as a laser scanner and has a rotatable deflection unit (34) for periodically scanning the monitoring region (16).

10. A method for detecting and determining the distance of objects in a monitoring region (16), wherein a transmission light beam (18) with a modulated pulse sequence coding is transmitted, a reception signal is generated in a light receiver (24) from a remitted light beam (20) remitted by objects in the monitoring region (16) and is evaluated taking into account the associated pulse sequence coding in order to determine a light time of flight and, therefrom, a distance value, wherein a plurality of transmission light beams (18) with a modulated pulse sequence coding are transmitted simultaneously for scanning a plurality of measuring points (28), a plurality of reception signals are generated from the remitted light beams (20) in different light receiving elements of the same light receiver (24) and these are correlated with the associated pulse sequence coding in order to determine respective distance values to the plurality of measuring points (28).

11. The method according to claim 10,
wherein the direction of at least one transmission light beam (18) is varied in order to illuminate another measuring point (28) and to receive the associated remitted light beam (20) in another light receiving element.
